(19) United States
(12) Patent Application Publication
(10) Pub. No.: US 2018/0090033 A1
(43) Pub. Date: Mar. 29, 2018

(54) Bankart Repair Surgery Proficiency Assessment System and Metrics for Assessment

(71) Applicant: Arthroscopy Association of North America, Rosemont, IL (US)

(72) Inventors: Anthony G. Gallagher, Newtownabbey (GB); Richard Ryu, Santa Barbara, CA (US); Robert Pedowitz, Encinitas, CA (US); Richard Angelo, Woodinville, WA (US)

(21) Appl. No.: 15/719,817

(22) Filed: Sep. 29, 2017

Related U.S. Application Data
(60) Provisional application No. 62/401,478, filed on Sep. 29, 2016.

(51) Int. Cl. G09B 23/32; G09B 9/00

(52) U.S. Cl. CPC G09B 23/32; G09B 9/00

(57) ABSTRACT

A simulator based training curriculum using validated metrics for an arthroscopic Bankart repair that appropriately characterize the procedure to be trained is provided. The simulation-based training gives trainees precise feedback on their performance with specific recommendations for improvement, proximate to the performance. Trainees are also provided a quantitative performance benchmark to work toward that provides a valid representation of their skill level in a clinically important performance characteristic or task. The trainee must demonstrate the ability to meet specific performance benchmarks before they are permitted to progress in their training program.

### CROSS REFERENCE TO RELATED APPLICATION

This application claims the benefit of U.S. provisional application No. 62/401,478 filed Sep. 29, 2016, the entire contents of which are hereby incorporated in its entirety by reference.

### BACKGROUND OF THE INVENTION

The present invention relates to a simulator assisted training process for acquiring surgery or other interventional procedure skills, for example, for arthroscopic surgery, and in particular to a proficiency-based progression training curriculum and metrics for training and testing individuals performing Bankart repair surgery or other interventional procedures.

The intent of any surgical or interventional training program, both for those in medical training, e.g., surgical residents, and for established surgeons acquiring a new procedural skill, is to enable the trainee to acquire the requisite skill sets necessary to perform the designated surgical procedure properly and safely. To accomplish this goal, a clearly defined endpoint or set of skill metrics must be identified. Furthermore, it must be verified that mastery of those skill sets can be measured accurately during the trainee's training. It must also be confirmed that the acquisition of those skills is predictive of the ability to perform an effective surgical procedure.

Traditionally, surgical residents have been trained using the “apprenticeship” model, dependent in part on exposure to surgical cases, variable graduated participation in surgery, and time spent on specific clinical rotations. Many experienced surgeons who are proficient in the performance of a specific procedure and are able to perform it properly are typically able to agree upon the essential “steps” to be completed, as well as the “errors” to be avoided, for that procedure. One challenge, however, in identifying those key features is that surgeons rarely think about the steps they perform or errors they avoid when performing the surgery. Surgeons who are proficient in the performance of a specific operation will exhibit many if not all of the important performance characteristics that contribute to actually performing the procedure well. They may, however, have automated many of the steps and how they are performed and, as a consequence, may be less cognizant of the steps and more specific details of the techniques they use.

### SUMMARY OF THE INVENTION

The present invention provides a simulator based training curriculum using validated metrics for an arthroscopic Bankart repair that appropriately characterize the procedure to be trained. The simulation-based training gives trainees precise feedback on their performance with specific recommendations for improvement, proximate to the performance. Trainees are also provided a quantitative performance benchmark to work toward that provides a valid representation of their skill level in a clinically important performance characteristic or task. The trainee must demonstrate the ability to meet specific performance benchmarks before they are permitted to progress in their training program.

In one embodiment of the invention, a method of training a trainee for a Bankart repair procedure by an expert using a set of metrics for evaluation is provided, the method having the steps of: (a) observing the trainee performing the Bankart repair procedure; (b) determining whether or not at least one step metric is performed by the trainee; (c) determining whether at least one error metric is avoided by the trainee; (d) inputting a first binary condition if the at least one step metric is performed and a second binary condition if the at least one step metric is not performed to produce results data; (e) inputting a third binary condition if the at least one error metric is performed and a fourth binary condition if the at least one error metric is not performed to produce results data; and (f) providing a summary report based upon the results data of the trainee's performance.

The at least one step metric may be at least one of: a discrete performance element, an order in which specific operative steps should be accomplished, and instruments and the manner in which they should be used.

The error metric may further include a special designation for events that could either jeopardize the outcome of the procedure or lead to significant iatrogenic damage.

The arthroscopic procedure may be performed on a shoulder joint model.

The trainee may be provided with at least one of the following instruments for performing the Bankart repair: obturator cannulas, switching sticks, hook probe, regular and looped graspers, liberator/elevator, shaver, drill guide/drill, push in anchor loaded with single suture, mallet, cannulated suture hook, penetrator, monofilament suture, knot pusher, and arthroscopic scissors.

The at least one step metric may be at least one of: posterior portal established, view posterior humeral head and extent of the Hill-Sachs when present, introduce mid-anterior spinal needle immediately superior to the subcapularis and direct it toward the anteroinferior glenoid and labrum, establish a cannula that abuts the superior border of the subscapularis near the lateral subscapularis insertion, demonstrate instrument access to the anteroinferior glenoid/labrum, introduce anterosuperior spinal needle at the superolateral aspect of the rotator interval and direct it toward the anterior glenoid, and establish an anterosuperior cannula, arthroscopic sheath, or switching stick.

The at least one error metric may be at least one of: failure to maintain intra-articular position of the posterior cannula, failure to maintain intra-articular position of the mid-anterior cannula, failure to maintain intra-articular position of the anterosuperior cannula, damage to the superior border of the subcapularis, and damage to the anterior border of the supraspinatus.

The at least one step metric may be at least one of: view or probe the superior labral attachment onto the glenoid, view or probe articular surface of the cuff, probe anteroinferior glenoid/Bankart pathology including rim fracture, articular defect, probe anteroinferior glenoid/Bankart pathology including rim fracture, articular defect, view or probe the mid-substance of the anterior-inferior glenohumeral ligaments, and view or probe the insertion of the anterior glenohumeral ligaments onto the anterior humeral neck.

The at least one error metric may be loss of intra-articular position of scope/sheath or operating cannula.

The at least one step metric may be at least one of: elevate the capsulolabral tissue from the glenoid next and articular margin, view the suscapularis muscle superficial to the mobilized capsule, with an instrument, grasp and perform an inferior to superior shift of the capsulolabral tissue (to restore tension), obtain a view of the anterior glenoid neck, and mechanically abrade the glenoid neck.

The at least one error metric may be at least one of: lacerate intact capsulolabral tissue, failure to maintain control of working instrument, and loss of intra-articular position of scope/sheath or operating cannula.

The at least one step metric may be at least one of: seat the guide for the most inferior anchor hole, drill anchor hole oblique to the glenoid articular face, insert anchor, and test suture anchor.

The at least one error metric may be at least one of: guide is not located in the inferior region of the anteroinferior quadrant of the glenoid, entry of the completed tunnel lies outside safe zone of 0 to 3 mm from the bony glenoid rim, shallow undermining and deformation of articular cartilage, failure to maintain secure seating of the drill guide during anchor insertion, breakage of the implant, implant remains visibly proud, failure to insert the anchor with the inserter laser line to or beyond the laser line on the drill guide, anchor fails to remain securely fixed within bone at the appropriate depth, and loss of intra-articular position of scope/sheath or operation cannula.

The at least one step metric may be at least one of: pass a cannulated suture hook or suture retriever through the capsule tissue, and pass anchor suture limb through the capsular tissue and deliver out the anterior cannula.

The at least one error metric may be at least one of: capsular penetration is at or superior to anchor hole, capsular penetration is not at or peripheral to the capsulolabral junction, instrument breakage, tearing of capsulolabral tissue, uncorrected entanglement of shuttling device or suture, off-loading the suture anchor, failure to maintain intra-articular position of the anterior or posterior cannula, damage to non-target tissue, offloading the suture anchor, failure to maintain intra-articular position of the anterior or posterior cannula, damage to non-target tissue, offloading the suture anchor, break suturing device, and loss of intra-articular position of scope/sheath or operating cannula.

The at least one step metric may be at least one of: deliver an arthroscopic knot, back up with 3 or 4 half hitches, and cut suture tails.

The at least one error metric may be at least one of: failure to create and maintain indentation of the capsule or labral tissue, visible void is present between throws of the completed primary knot, completed knot abuts articular cartilage, visible void is present between throws of the complete half hitches, suture breakage, and loss of intra-articular position of scope/sheath or operating cannula.

In one embodiment of the present invention a method of training a trainee for a Bankart repair procedure using a set of metrics for evaluation is provided, the method having the steps of: (a) recording a video of the trainee performing the Bankart repair procedure; (b) reviewing the video of the trainee performing the Bankart repair procedure; (c) determining whether or not at least one step metric is performed; (d) inputting a first binary condition if the at least one step metric is performed and a second binary condition if the at least one step metric is not performed to produce results data; (e) determining whether at least one error metric is avoided by the trainee; (f) inputting a third binary condition if the at least one error metric is performed and a fourth binary condition if the at least one error metric is not performed to produce results data; and (e) providing a summary report based upon the results data of the trainee's performance.

The at least one step metric may be inserting three anchors oblique to the glenoid articular face. The three anchors may be positioned at posterior, anterosuperior and mid-anterior positions within the glenoid articular face.

One of the features of the present invention is to standardize the evaluation metrics of trainee performance for a Bankart repair procedure.

Another feature of the present invention is to provide evaluation methods for Bankart repair procedure, which remains a challenge because it requires ambidextrous triangulation by the surgeon in three dimensions while being guided by a two-dimensional video display, which may be difficult to observe.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a simplified perspective view of a trainee performing an arthroscopic procedure according to the present invention providing a video camera recording the trainee's steps;

FIG. 2 is a simplified perspective view of a computer based evaluation system suitable for use in the present invention providing an expert interacting with trainee video as taken in FIG. 1 and a computer processing evaluation software;

FIG. 3 is an example evaluation data scoresheet presented on an input monitor of FIG. 2 for use by the expert for use in entering data related to the evaluation of the trainee video of arthroscopic procedure;

FIG. 4 is an example summary report outputted by the evaluation software of FIG. 2 providing feedback on the trainee's performance based upon the trainee's evaluation data scoresheet;

FIG. 5 is a flowchart of the method performed during the evaluation of the trainee's performance; and

FIG. 6 is a flowchart of the evaluation software executed by the computer of FIG. 2 for implementing the evaluation system.

In describing the embodiment of the invention, which is illustrated in the drawings, specific terminology will be resorted to for the sake of clarity. However, it is not intended that the invention be limited to the specific terms so selected and it is to be understood that each specific term includes all technical equivalents, which operate in a similar manner to accomplish a similar purpose. For example, the words “connected”, “attached”, or terms similar thereto are often used. They are not limited to direct connection but include connection through other elements where such connection is recognized as being equivalent by those skilled in the art.

### DETAILED DESCRIPTION OF THE INVENTION

The various features and advantageous details of the subject matter disclosed herein are explained more fully with reference to the non-limiting embodiments described in detail in the following description.

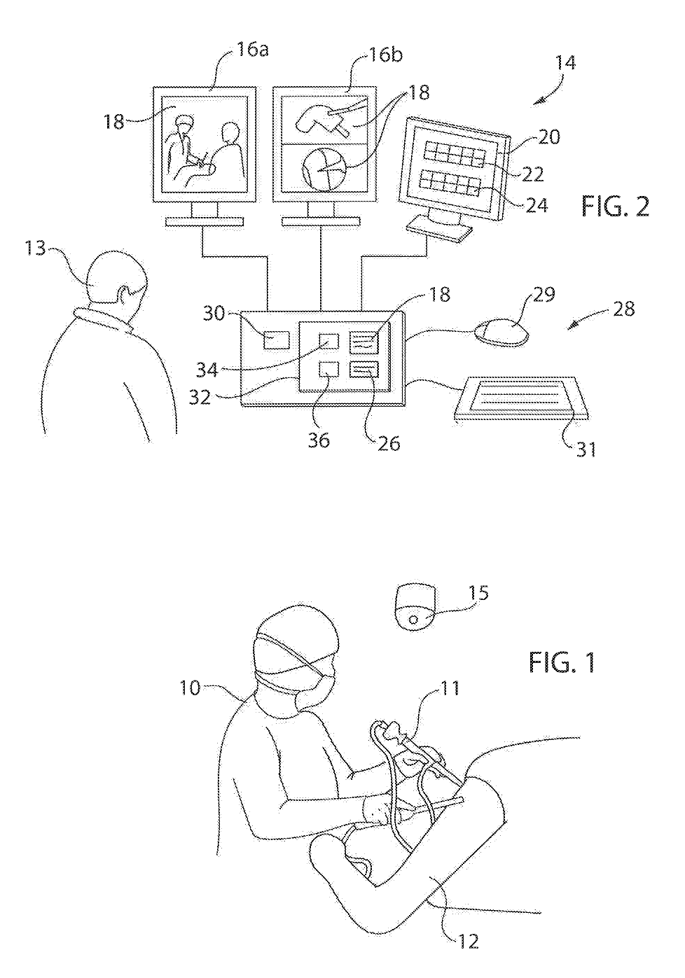

Referring to FIG. 1, a trainee 10 is instructed to perform a predetermined surgical technique (e.g., arthroscopic Bankart repair), such as on a simulator model 12 or human cadaver facilitating performance evaluation. In the illustrated and described embodiment, the surgical technique may be an arthroscopic repair of a shoulder, although it is understood that the present invention also contemplates other surgical procedures. For example, the trainee 10 may be instructed to establish ports or portals in the shoulder joint (e.g., posterior, anterosuperior, and mid-anterior), complete a thorough diagnostic arthroscopy, and/or perform a three anchor arthroscopic Bankart repair on the simulator model 12. They may be instructed to demonstrate and complete all of the steps for the Bankart repair that they would normally perform in clinical practice on a real patient. During skills assessment, coaching of the trainee 10 is not allowed although the trainee 10 may be assisted by a surgical assistant who may only act under the specific direction of the trainee 10. The trainee 10 is provided all standard instruments 11 necessary to complete an arthroscopic Bankart repair such as 5.5 and 8.5 mm obturator cannulas, switching sticks, hook probe, regular and looped graspers, liberator/elevator, shaver, drill guide/drill, push in anchor loaded with single suture, mallet, cannulated suture hook, penetrator, monofilament suture, knot pusher, and arthroscopic scissors.

A continuous video recording may be made with a camera 15 beginning with the first arthroscopic view of the joint from the posterior portal and ending with the withdrawal of the arthroscope after the trainee's examination of the completed repair with a hook probe. There may be multiple cameras 15 and the cameras 15 may capture different angles or perspectives of the procedure (e.g., view from the posterior portal or anterosuperior portal). The video recordings are stored in memory 32 for expert 13 evaluations, to be further described below.

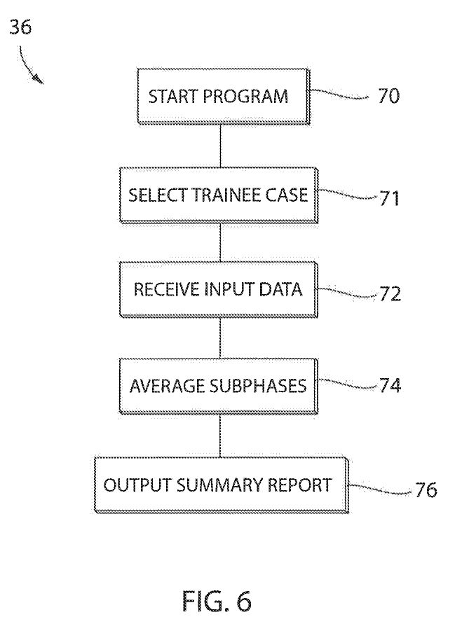

Referring now to FIGS. 2 and 6, an assessment tool 14 for trainee performance scoring may provide one or more video display monitors 16a and 16b for displaying video images 18 of the type acquired by the camera 15 during the shoulder simulator model 12 testing described above. The video display monitor or monitors 16a and 16b may be located in a separate room from the testing. The video images 18 may be played in real time and evaluated by the expert 13 or may be stored in memory 32 so that the expert 13 may play back the video images 18 and review the video images 18 as many times as necessary to properly review the trainee's performance.

Each of the monitors 16a, 16b, 20 may connect to a processor 30 also connecting to data input devices 28 including, for example, a mouse 29 and keyboard 31 according to techniques and standards well understood in the art. The processor 30 may communicate with an electronic memory 32. The electronic memory 32 may be a logical combination of multiple memory devices including random access memory, disk drive memory, and the like.

The electronic memory 32 may hold a commercially available operating system 34 as well as a simulation program 36 of the present invention executed as further described below. In addition, the electronic memory 32 may hold the video images 18 that will be reviewed by the expert 13 and the procedural evaluation data scoresheet 26 into which the expert 13 enters data.

Once the program is initiated by the expert 13, as illustrated by step 70 of the simulation program 36, a computer monitor 20 may provide a list of cases 22 to be selected by the expert 13, as illustrated by step 71 of the simulation program 36, and reviewed by the expert by entering data into an evaluation report input table 24 providing a procedural evaluation data scoresheet 26, as illustrated by step 72.

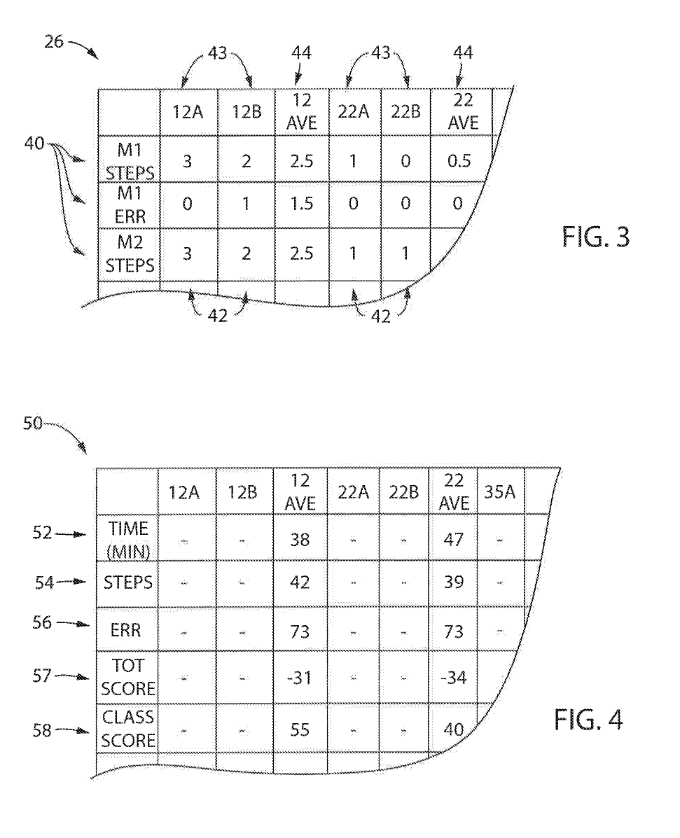

Referring now to FIGS. 3 and 6, the procedural evaluation data scoresheet 26 may be represented as a logical table listing different testing metrics 40 (represented by rows) and tying them to evaluation scores 42 organized into different sub-phases 43 of the procedure (represented by columns) as either occurring or not occurring, as evaluated by the expert 13 during step 72. The sub-phases 43 may be added together and averaged to provide an average total step and total error score 44 for each phase by the simulation program 36 as represented by step 74.

Metrics 40 may include discrete performance elements (steps), the order in which specific operative steps should be accomplished, and/or the instruments and the manner in which they should be used. Metrics 40 may also include deviations from optimal performance that should be avoided (errors), Additional metrics 40 may include special designations for more serious or “sentinel” errors defined by events that, by themselves, could either jeopardize the outcome of the procedure or lead to significant iatrogenic damage to the shoulder joint. “Sentinel” errors may be assigned greater weight or importance in scoring or scored separately due to the greater gravity of the error. In order to maintain consistency in evaluation it may be desired to apply the convention that an event must be observed on video to be scored. The clinical evaluation data scoresheet 26 may also allow input of comments from the expert 13 for each metric 40.

For all such metrics 40, the metric 40 may be scored in binary fashion, for example, as either yes (1) or no (0) (occurring or not occurring). Other binary values or bits may represent occurring or not occurring. It is understood that the metric 40 may also be scored in analog fashion, providing a value within a substantially continuous range, for example, indicating a degree of occurrence.

Referring to FIGS. 4 and 6, following input of procedural evaluation data scoresheet 26 during step 72 by the expert, the simulation program 36 may be programmed to provide the trainee 10 with a summary report 50 of his or her performance and accurate feedback based upon the procedural evaluation data scoresheet 26 as represented by step 76. The total time 52 in seconds, minutes and/or hours taken by the trainee to perform the diagnostic and procedural components in each video may be provided in the summary report 50. The evaluation scores 42 for multiple experts 13 evaluating the same trainee 10 may be added together and averaged to provide average scores, namely, an average steps score 54 and an average error score 56 provided in the summary report 50 for each phase. The summary report 50 may also contain a total cumulative score 57 taking into account or adding together the step and error scores for sub-phases 43 or the entire procedure. An indication of discrepancy between different experts' scores may also be indicated in the summary report 50. The performance data for all trainees may also he averaged 58 to determine class progress and performance benchmarks as a whole so that the trainee 10 can compare their progress with their peers.

### Example

The Bankart procedure metrics are grouped into 13 separate phases of the procedure. Each phase contains a series of related, unambiguously defined, observable procedure events (steps) with specific beginning and ending points to be evaluated. There are also errors and sentinel errors for the expert to look out for throughout the procedure. The Bankart procedure metrics include 45 steps, 77 errors (29 unique), and 20 sentinel errors (8 unique). The metrics are listed below in table 1.

As can be seen in Table 1, a first subsection “Portals” may include the following steps: posterior portal established, view posterior humeral head and extent of the Hill-Sachs when present, introduce mid-anterior spinal needle immediately superior to the subcapularis and direct it toward the anteroinferior glenoid and labrum, establish a cannula that abuts the superior border of the subscapularis near the lateral subscapularis insertion, demonstrate instrument access to the anteroinferior glenoid/labrum, introduce anterosuperior spinal needle at the superolateral aspect of the rotator interval and direct it toward the anterior glenoid, and establish an anterosuperior cannula, arthroscopic sheath, or switching stick. Damage to non-target tissue may be observed during these steps. The first subsection “Portals” may include the following errors: failure to maintain intra-articular position of the posterior cannula, failure to maintain intra-articular position of the mid-anterior cannula, failure to maintain intra-articular position of the anterosuperior cannula, damage to the superior border of the subcapularis, and damage to the anterior border of the supraspinatus.

A second subsection “Arthroscopic Instability Assessment” may include the following steps: view or probe the superior labral attachment onto the glenoid (view from posterior portal), view or probe articular surface of the cuff (view from posterior portal), probe anteroinferior glenoid/Bankart pathology including rim fracture, articular defect (view from posterior portal), probe anteroinferior glenoid/Bankart pathology including rim fracture, articular defect (view from posterior portal), view or probe the mid-substance of the anterior-inferior glenohumeral ligaments (view from anterosuperior portal), and view or probe the insertion of the anterior glenohumeral ligaments onto the anterior humeral neck (view from anterosuperior portal). Damage to non-target tissue may be observed during these steps. The second subsection “Arthroscopic Instability Assessment” may include the following error: loss of intra-articular position of scope/sheath or operating cannula (loss of each portal is scored only once for each subsection, i.e., up to a total of 3 for scope+2 portals).

A third subsection “Capsulolabral Mobilization/Glenoid Preparation” may include the following steps: elevate the capsulolabral tissue from the glenoid next and articular margin, view the suscapularis muscle superficial to the mobilized capsule, with an instrument, grasp and perform an inferior to superior shift of the capsulolabral tissue (to restore tension), obtain a view of the anterior glenoid neck, and mechanically abrade the glenoid neck. Damage to non-target tissue may be observed during these steps. The third subsection “Capsulolabral Mobilization/Glenoid Preparation” may include the following errors: lacerate intact capsulolabral tissue (sentinel error), failure to maintain control of working instrument (sentinel error), and loss of intra-articular position of scope/sheath or operating cannula (loss of each portal is scored only once for each subsection, i.e., up to a total of 3 for scope+2 portals).

A fourth subsection “Inferior Anchor Preparation/Insertion” may include the following steps: seat the guide for the most inferior anchor hole, drill anchor hole oblique to the glenoid articular face, insert anchor, and test suture anchor. Damage to non-target tissue may be observed during these steps. The fourth subsection “Inferior Anchor Preparation/Insertion” may include the following errors: guide is not located in the inferior region of the anteroinferior quadrant of the glenoid, entry of the completed tunnel lies outside safe zone of 0 to 3 mm from the bony glenoid rim (sentinel error), shallow undermining and deformation of articular cartilage (sentinel error), failure to maintain secure seating of the drill guide during anchor insertion, breakage of the implant, implant remains visibly proud (sentinel error), failure to insert the anchor with the inserter laser line (when present) to or beyond the laser line on the drill guide, anchor fails to remain securely fixed within bone at the appropriate depth, and loss of intra-articular position of scope/sheath or operation cannula (loss of each portal is scored only once for each subsection, i.e., up to a total of 3 for scope+2 portals).

A fifth subsection “Suture Delivery/Management” may include the following steps: pass a cannulated suture hook or suture retriever through the capsule tissue, and pass anchor suture limb through the capsular tissue and deliver out the anterior cannula. Damage to non-target tissue may be observed during these steps. The fifth subsection “Suture Delivery/Management” may include the following errors: capsular penetration is at or superior to anchor hole (sentinel error), capsular penetration is not at or peripheral to the capsulolabral junction, instrument breakage, tearing of capsulolabral tissue, uncorrected entanglement of shuttling device or suture, off-loading the suture anchor, failure to maintain intra-articular position of the anterior or posterior cannula, damage to non-target tissue, off-loading the suture anchor, failure to maintain intra-articular position of the anterior or posterior cannula, damage to non-target tissue, off-loading the suture anchor, break suturing device, and loss of intra-articular position of scope/sheath or operating cannula (loss of each portal is scored only once for each subsection, i.e., up to a total of 3 for scope+2 portals).

A sixth subsection “Knot-tying” may include the following steps: deliver an arthroscopic knot, back up with 3 or 4 half hitches, and cut suture tails. Damage to non-target tissue may be observed during these steps. The sixth subsection “Knot-tying” may include the following errors: failure to create and maintain indentation of the capsule or labral tissue (sentinel error), visible void is present between throws of the completed primary knot (sentinel error), completed knot abuts articular cartilage, visible void is present between throws of the complete half hitches, suture breakage, and loss of intra-articular position of scope/sheath or operating cannula (loss of each portal is scored only once for each subsection, i.e., up to a total of 3 for scope+2 portals).

A seventh subsection “Second Anchor Preparation/Insertion” may include the following steps: seat the drill guide for the second anchor, drill anchor hole oblique to the glenoid articular face, insert suture anchor, and test anchor security by pulling on suture tails. Damage to non-target tissue may be observed during these steps. The seventh subsection “Second Anchor Preparation/insertion” may include the following errors: guide is not located superior to the first anchor and at or below the glenoid equator, entry of the completed tunnel lies outside safe zone of 0 to 3 mm from the bony glenoid rim (sentinel error), shallow undermining and deformation of articular cartilage (sentinel error), failure to maintain secure seating of the drill guide during anchor insertion, breakage of the implant, implant remains visibly proud (sentinel error), failure to insert the anchor with the inserter laser line (when present) to or beyond the laser line on the drill guide, anchor fails to remain securely fixed within bone at the appropriate depth, and loss of intra-articular position of scope/sheath or operating cannula (loss of each portal is scored only once for each subsection, i.e., up to a total of 3 for scope+2 portals).

An eighth subsection “Suture Delivery/Management” may include the following steps: pass a cannulated suture hook or suture retriever through the capsular tissue, and pass anchor suture limb through the capsular tissue and deliver out the anterior cannula. Damage to non-target tissue may be observed during these steps. The eighth subsection “Suture Delivery/Management” may include the following errors: capsular penetration is superior to anchor hole (sentinel error), capsular penetration is not at or peripheral to the capsulolabral junction, tearing of capsulolabral tissue, instrument breakage, uncorrected entanglement of shuttling device or suture, off-loading the suture anchor, break suturing device, and loss of intra-articular position of scope/sheath or operating cannula (loss of each portal is scored only once for each subsection, i.e., up to a total of 3 for scope+2 portals).

A ninth subsection “Knot-tying” may include the following steps: deliver an arthroscopic knot, back up with 3 or 4 half hitches, and cut suture tails. Damage to non-target tissue may be observed during these steps. The ninth subsection “Knot-tying” may include the following errors: failure to create and maintain indentation of the capsule or labral tissue (sentinel error), visible void is present between throws of the completed primary knot (sentinel error), completed knot abuts articular cartilage, visible void is present between throws of the complete half hitches, suture breakage, and loss of intra-articular position of scope/sheath or operating cannula (loss of each portal is scored only once for each subsection, i.e., up to a total of 3 for scope+2 portals).

A tenth subsection “Third Anchor Preparation/Insertion” may include the following steps: seat the drill guide for the third anchor, drill anchor hole oblique to the glenoid articular face, insert suture anchor, and test anchor security by pulling on suture tails. Damage to non-target tissue may be observed during these steps. The tenth subsection “Third Anchor Preparation/insertion” may include the following errors: guide is inferior to the equator of the glenoid, entry of the completed tunnel lies outside safe zone of 0 to 3 mm from the bony glenoid rim (sentinel error), shallow undermining and deformation of the articular cartilage (sentinel error), failure to maintain secure seating of the drill guide during anchor insertion, breakage of the implant, implant remains visibly proud (sentinel error), failure to insert the anchor with the inserter laser line (when present) to or beyond the laser line on the drill guide, anchor fails to remain securely fixed within bone at the appropriate depth, loss of intra-articular position of scope/sheath or operating cannula (loss of each portal is scored only once for each subsection, i.e., up to a total of 3 for scope+2 portals).

An eleventh subsection “Suture Delivery/Management” may include the following steps: pass a cannulated suture hook or suture retriever through the capsular tissue, and pass anchor suture limb through the capsular tissue and deliver out the anterior cannula. Damage to non-target tissue may be observed during these steps. The eleventh subsection “Suture Delivery/Management” may include the following errors: capsular penetration is superior to anchor hole (sentinel error), capsular penetration is not at or peripheral to the capsulolabral junction, tearing of the capsulolabral tissue, instrument breakage, uncorrected entanglement of shuttling device or suture, off-loading the suture anchor, break shuttling device, and loss of intra-articular position of scope/sheath or operating cannula (loss of each portal is scored only once for each subsection, i.e., up to a total of 3 for scope+2 portals).

A twelfth subsection “Knot-tying” may include the following steps: deliver an arthroscopic knot, back up with 3 or 4 half hitches, and cut suture tails. Damage to non-target tissue may be observed during these steps. The twelfth subsection “Knot-tying” may include the following errors: failure to create and maintain indentation of the capsule of labral tissue (sentinel error), visible void is present between throws of the completed primary knot (sentinel error), completed knot abuts articular cartilage, visible void is present between throws of the complete half hitches, suture breakage, and loss of intra-articular position of scope/sheath or operating cannula (loss of each portal is scored only once for each subsection, i.e., up to a total of 3 for scope+2 portals).

A thirteenth subsection “Procedure Review” may include the following step: view and/or probe final completed repair. Damage to non-target tissue may be observed during this step.

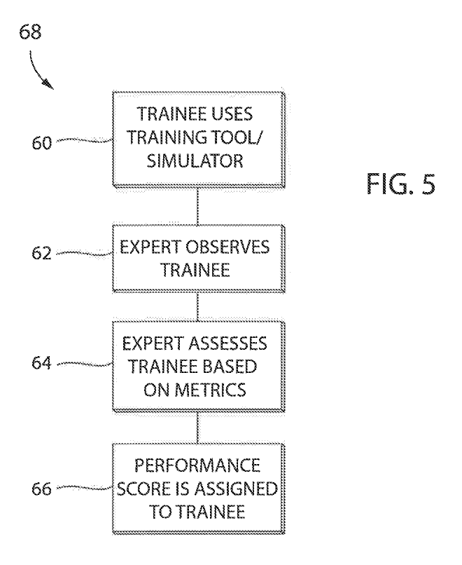

Referring to FIG. 5, a method of training the trainee 10 on a surgical/procedural technique is represented by flow chart 68. The trainee 10 is instructed to perform a specific surgical task on the training tool or simulator 12 as represented by step 60. The task may include an arthroscopic Bankart procedure or another procedure. The specific surgical task is associated with a list of detailed metrics 40, defining the proper “steps” to be performed during the task and the unwanted “errors” commonly encountered during the task. The metrics 40 are generally unique to each specific surgical task.

The expert(s) 13 observes the trainee's performance in person or in a recording of the performance that is played back as represented by step 62. The expert(s) 13 then uses an assessment tool 14 to score the trainee 10 on the plurality of metrics 40 as represented by step 64. The assessment asks whether the metric 40 (step or error) occurs or does not occur during the trainee's surgical task, thus, minimizing any review bias occurring in a more qualitative analysis. Once the expert(s) 13 has completed the assessment, the scores are calculated to provide the trainee 10 summary performance scores and other evaluation information (such as expert 13 notes) as represented by step 66. The scores provide feedback to the trainee 10 in a timely manner, close in time to the performance of the task. Based upon the trainee's score, the trainee may use the feedback to improve their performance and if successful may advance to a higher stage of training. The specificity of the scores allows the trainee 10 to practice specific metrics and aspects of the task for a more deliberate training method.

Referring to FIG. 6, the simulation program 36 used in evaluating the trainee's performance may be started by the expert 13 as initiated at step 70. At the start of evaluation, the expert 13 may choose from a list of cases 22 as initiated by the expert at step 71 to provide an evaluation report input table 24 into which the expert 13 may enter data into a procedural evaluation data scoresheet 26 for a particular trainee 10 as represented by step 72. The data is entered and stored by the program 36 where the program 36 may be programmed to divide the inputted data into sub-phases 43 and add together and average the data to provide an average total step and total error score 44 for each sub-phase. The program 36 may also add together and average the data for all sub-phases to provide an average total step and total error score for the entire procedure. The simulation program 36 may be programmed to provide the trainee 10 with a summary report 50 of his or her performance where this summary report 50 may be aggregated among experts for a particular trainee 10 or among trainees 10 to provide representative class data.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing, elements or features of the present disclosure and the exemplary embodiments, the articles “a”, “an”, the and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a controller” and “a processor” should be understood to include one or more microprocessors that can communicate in a stand-atone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A method of training a trainee for a Bankart repair procedure by an expert using a set of metrics for evaluation, the method comprising the steps of:
(a) observing the trainee performing the Bankart repair procedure;
(b) determining whether or not at least one step metric is performed by the trainee;
(c) determining whether at least one error metric is avoided by the trainee;
(d) inputting a first binary condition if the at least one step metric is performed and a second binary condition if the at least one step metric is not performed to produce results data;
(e) inputting a third binary condition if the at least one error metric is performed and a fourth binary condition if the at least one error metric is not performed to produce results data; and
(f) providing a summary report based upon the results data of the trainee's performance.

2. The method of claim 1, wherein the at least one step metric is at least one of: a discrete performance element, an order in which specific operative steps should be accomplished, and instruments and the manner in which they should be used.

3. The method of claim 1, wherein the at least one error metric further includes a special designation for events that could either jeopardize the outcome of the procedure or lead to significant iatrogenic damage.

4. The method of claim 1, wherein the arthroscopic procedure is performed on a shoulder joint model.

5. The method of claim 1, wherein the trainee is provided with at least one of the following instruments for performing the Bankart repair: obturator cannulas, switching sticks, hook probe, regular and looped graspers, liberator/elevator, shaver, drill guide/drill, push in anchor loaded with single suture, mallet, cannulated suture hook, penetrator, monofilament suture, knot pusher, and arthroscopic scissors.

6. The method of claim 1, wherein the at least one step metric is at least one of: posterior portal established, view posterior humeral head and extent of the Hill-Sachs when present, introduce mid-anterior spinal needle immediately superior to the subcapularis and direct it toward the anteroinferior glenoid and labrum, establish a cannula that abuts the superior border of the subscapularis near the lateral subscapularis insertion, demonstrate instrument access to the anteroinferior glenoid/labrum, introduce anterosuperior spinal needle at the superolateral aspect of the rotator interval and direct it toward the anterior glenoid, and establish an anterosuperior cannula, arthroscopic sheath, or switching stick.

7. The method of claim 6, wherein the at least one error metric is at least one of: failure to maintain intra-articular position of the posterior cannula, failure to maintain intra-articular position of the mid-anterior cannula, failure to maintain intra-articular position of the anterosuperior cannula, damage to the superior border of the subcapularis, and damage to the anterior border of the supraspinatus.

8. The method of claim 1, wherein the at least one step metric is at least one of: view or probe the superior labral attachment onto the glenoid, view or probe articular surface of the cuff, probe anteroinferior glenoid/Bankart pathology including rim fracture, articular defect, probe anteroinferior glenoid/Bankart pathology including rim fracture, articular defect, view or probe the raid-substance of the anterior-inferior glenohumeral ligaments, and view or probe the insertion of the anterior glenohumeral ligaments onto the anterior humeral neck.

9. The method of claim 8, wherein the at least one error metric is loss of intra-articular position of scope/sheath or operating cannula.

10. The method of claim 1, wherein the at least one step metric is at least one of: elevate the capsulolabral tissue from the glenoid next and articular margin, view the suscapularis muscle superficial to the mobilized capsule, with an instrument, grasp and perform an. inferior to superior shift of the capsulolabral tissue (to restore tension), obtain a view of the anterior glenoid neck, and mechanically abrade the glenoid neck.

11. The method of claim 10, wherein the at least one error metric is at least one of: lacerate intact capsulolabral tissue, failure to maintain control of working instrument, and loss of intra-articular position of scope/sheath or operating cannula.

12. The method of claim 1, wherein the at least one step metric is at least one of: seat the guide for the most inferior anchor hole, drill anchor hole oblique to the glenoid articular face, insert anchor, and test suture anchor.

13. The method of claim 12, wherein the at least one error metric is at least one of: guide is not located in the inferior region of the anteroinferior quadrant of the glenoid, entry of the completed tunnel lies outside safe zone of 0 to 3 mm from the bony glenoid rim, shallow undermining and deformation of articular cartilage, failure to maintain secure seating of the drill guide during anchor insertion, breakage of the implant, implant remains visibly proud, failure to insert the anchor with the inserter laser line to or beyond the laser line on the drill guide, anchor fails to remain securely fixed within bone at the appropriate depth, and loss of intra-articular position of scope/sheath or operation cannula.

14. The method of claim 1, wherein the at least one step metric is at least one of: pass a cannulated suture hook or suture retriever through the capsule tissue, and pass anchor suture limb through the capsular tissue and deliver out the anterior cannula.

15. The method of claim 14, wherein the at least one error metric is at least one of: capsular penetration is at or superior to anchor hole, capsular penetration is not at or peripheral to the capsulolabral junction, instrument breakage, tearing of capsulolabral tissue, uncorrected entanglement of shuttling device or suture, off-loading the suture anchor, failure to maintain intra-articular position of the anterior or posterior cannula, damage to non-target tissue, offloading the suture anchor, failure to maintain intra-articular position of the anterior or posterior cannula, damage to non-target tissue, off-loading the suture anchor, break suturing device, and loss of intra-articular position of scope/sheath or operating cannula.

16. The method of claim 1, wherein the at least one step metric is at least one of: deliver an arthroscopic knot, back up with 3 or 4 half hitches, and cut suture tails.

17. The method of claim 16, wherein the at least one error metric is at least one of: failure to create and maintain indentation of the capsule or labral tissue, visible void is present between throws of the completed primary knot, completed knot abuts articular cartilage, visible void is present between throws of the complete half hitches, suture breakage, and loss of intra-articular position of scope/sheath or operating cannula.

18. A method of training a trainee for a Bankart repair procedure using a set of metrics for evaluation, the method comprising the steps of:
(a) observing the trainee performing the Bankart repair procedure;
(b) determining whether or not at least one step metric is performed;
(d) inputting a first binary condition if the at least one step metric is performed and a second binary condition if the at least one step metric is not performed to produce results data;
(e) providing a summary report based upon the results data of the trainee's performance.

19. The method of claim 18, wherein the at least one step metric is inserting three anchors oblique to the glenoid articular face.

20. The method of claim 19, wherein the three anchors are positioned at posterior, anterosuperior and mid-anterior positions within the glenoid articular face.
